(19) United States
(12) Patent Application Publication
(10) Pub. No.: US 2026/0317212 A1
(43) Pub. Date: Oct. 15, 2026

(54) WATER H2S STRIPPING TOWER

(71) Applicant: WIJG Development, LLC, Lewes, DE (US)

(72) Inventors: Floyd Hammond, Rogers, AR (US); Sirlance Nolasco, San Antonio, TX (US); Joseph Lanham, Tomball, TX (US)

(21) Appl. No.: 19/647,493

(22) Filed: Apr. 14, 2026

Related U.S. Application Data
(60) Provisional application No. 63/788,634, filed on Apr. 14, 2025.
(60) Provisional application No. 63/866,056, filed on Aug. 18, 2025.

(51) Int. Cl. C02F 1/58; C02F 1/28; C02F 101/10; C02F 103/34

(52) U.S. Cl. CPC C02F 1/58; C02F 1/286; C02F 2101/101; C02F 2103/34; C02F 2201/004

(57) ABSTRACT

A stripping tower has a water inlet, a sweet gas inlet and a water outlet. Water flows over a plurality of vertically spaced trays with gas-liquid contact devices thereon and sweet gas is injected into the water though the gas-liquid contact devices. A seal pad reverses the direction of the flow of the water from a downward direction to an upward direction before the water passes out of the stripping tower through the water outlet.

### CROSS REFERENCE TO RELATED APPLICATIONS

The present application claims priority to U.S. Provisional Application No. 63/788,634 filed on Apr. 14, 2025, and U.S. Provisional Application No. 63/866,056 filed on Aug. 18, 2025, which are incorporated herein by reference.

### FIELD

The field relates to systems for removing hydrogen sulfide (H₂S) from water.

### BACKGROUND

Hydrogen sulfide (H₂S) is a hazardous component in produced water and other aqueous streams that must be removed before transportation, reinjection, or disposal. Conventional stripping towers often fail to fully optimize gas-liquid interaction in water systems, leading to incomplete H₂S removal, increased chemical costs, and operational inefficiencies.

Current stripping towers typically rely on standard bubble cap trays, sieve trays, or random packing, which lack design features for managing residence time, vapor re-entrainment, and final polish separation. Without extended downcomers, submerged seal pads, and mist elimination, conventional systems suffer from uneven flow distribution, excessive sweet gas consumption, and incomplete H₂S removal. These limitations result in higher operational costs and reduced treatment efficiency, especially at large water throughput rates.

### BRIEF DESCRIPTION OF THE DRAWINGS

FIG. 1 is a front view of a stripping tower.

FIG. 2 is a left side view of the stripping tower.

FIG. 3 is a top view of the stripping tower.

FIG. 4 is an orthogonal view of the inside of the stripping tower.

FIG. 5 is an additional orthogonal view of the inside of the stripping tower rotated ninety degrees from FIG. 4.

FIG. 6 is a plan view of internal features of the stripping tower.

FIG. 7 is a view looking at the interior of an upper part of the stripping tower.

FIG. 8 is a view looking at the interior of the bottom of the stripping tower.

FIG. 9 is a top view of a tray used in the stripping tower.

FIG. 10 is an orthogonal view of the tray of FIG. 9.

FIG. 11 is a top view of an additional tray for the stripping tower.

FIG. 12 is an orthogonal view of the tray of FIG. 11.

FIG. 13 is a connecting ring for the tray of FIG. 9.

FIG. 14 is a connecting ring for the tray of FIG. 11.

FIG. 15 is a view of a gas inlet baffle.

FIG. 16 is a view of a vortex breaker.

FIG. 17 is an example of a vortex breaker installed in a tower.

FIG. 18 is a drawing of a bubble cap that may be used with the stripping tower.

FIG. 19 is an example of a chimney that may be used with the stripping tower.

FIG. 20 is an elevation view of showing some internal components of a single pass tower.

FIG. 21 is a top view of a tray for a single pass tower.

FIG. 22 is an orthogonal view of a tray for a single pass tower.

FIG. 23 is a view of a tray with a chimney in a single pass tower.

FIG. 24 is a support ring for a tray in a single pass tower.

FIG. 25 is a graph of a hypothetical model.

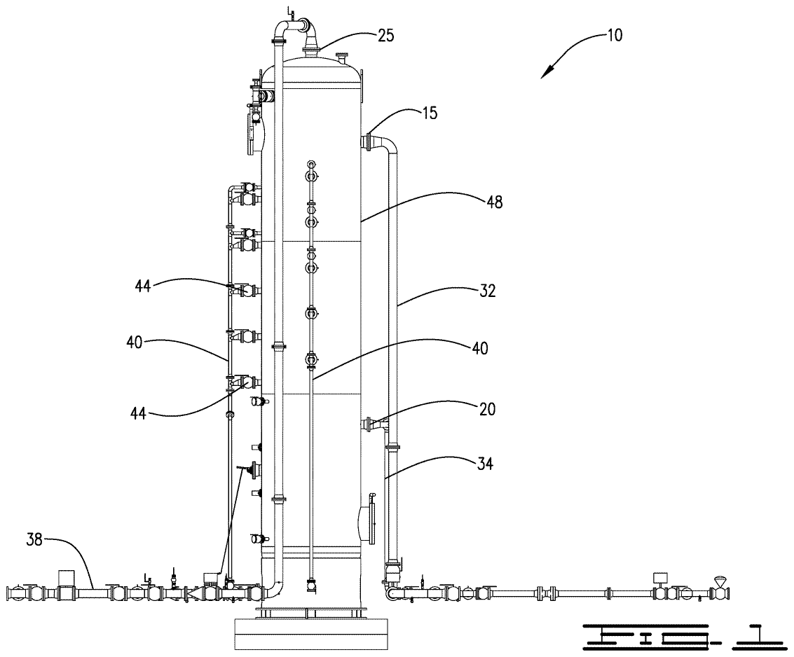

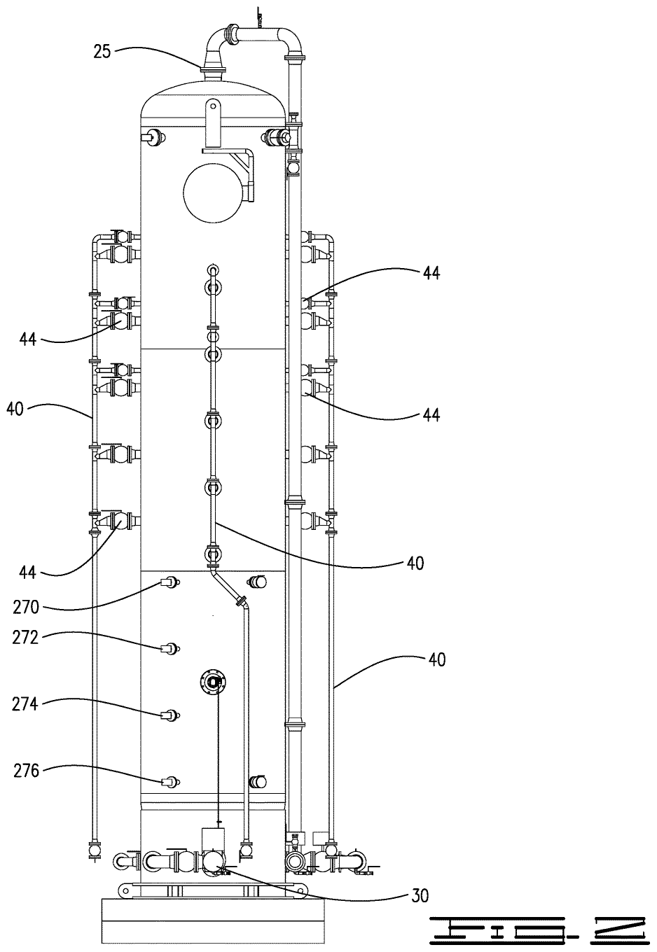

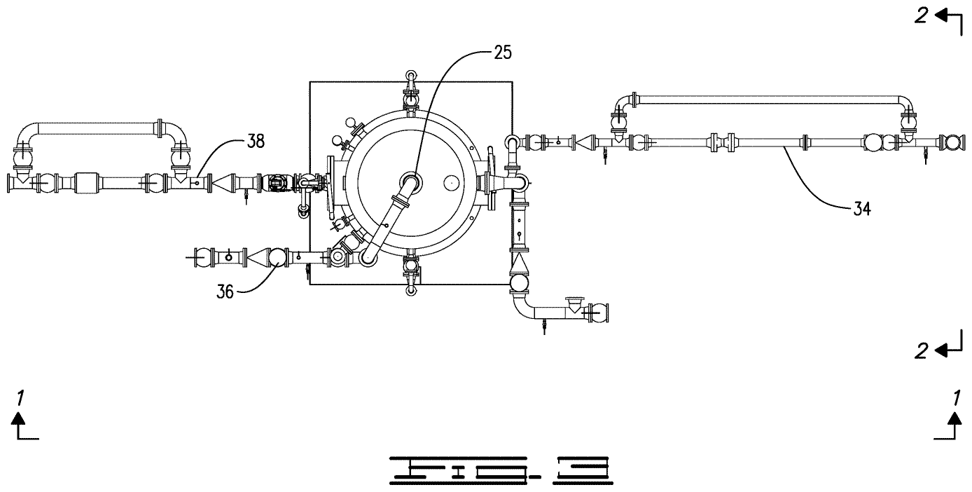

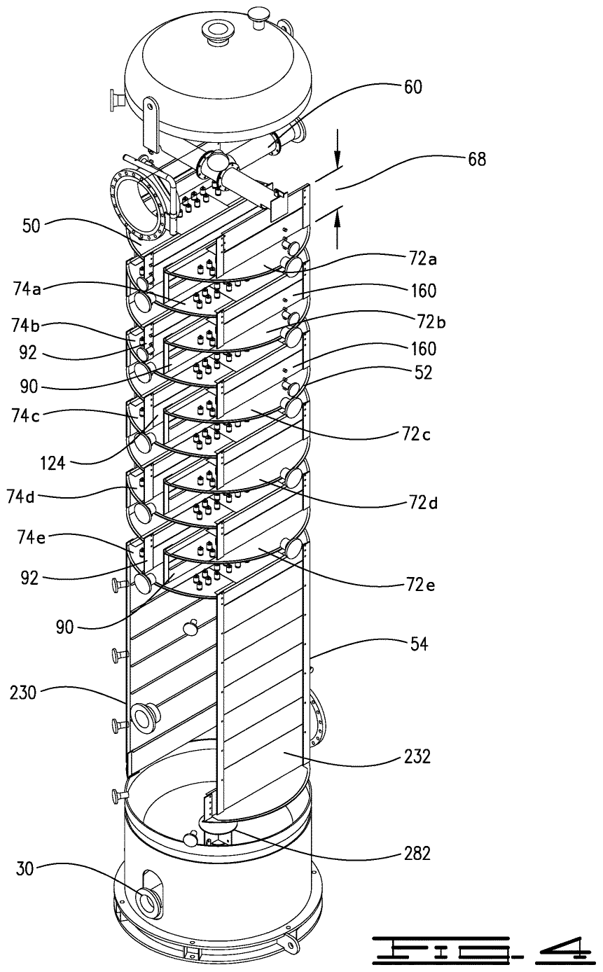

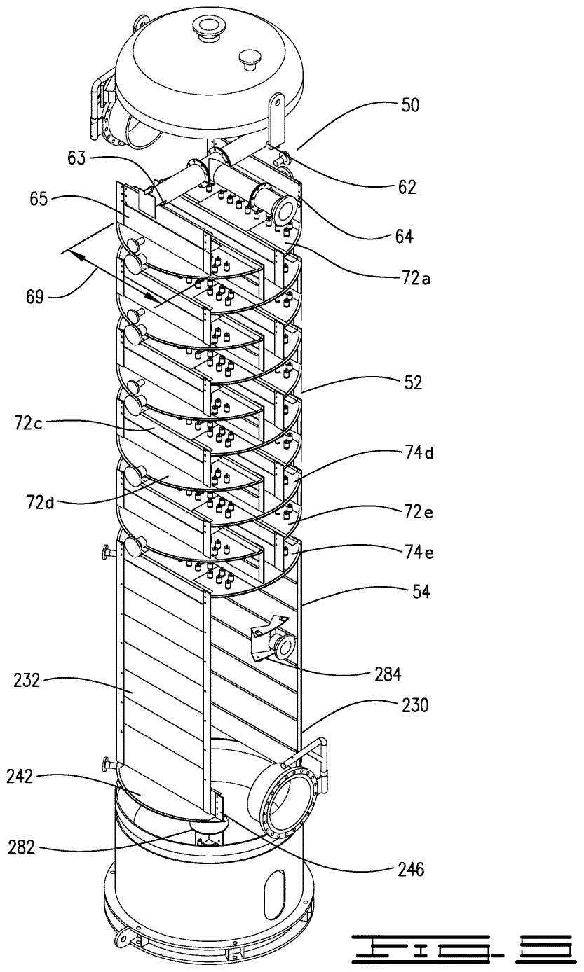

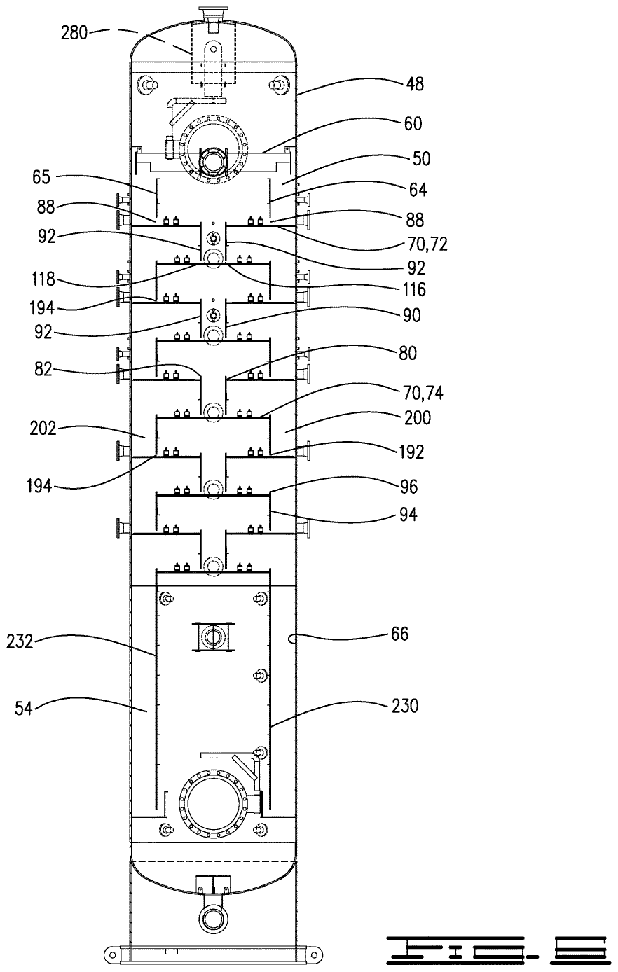

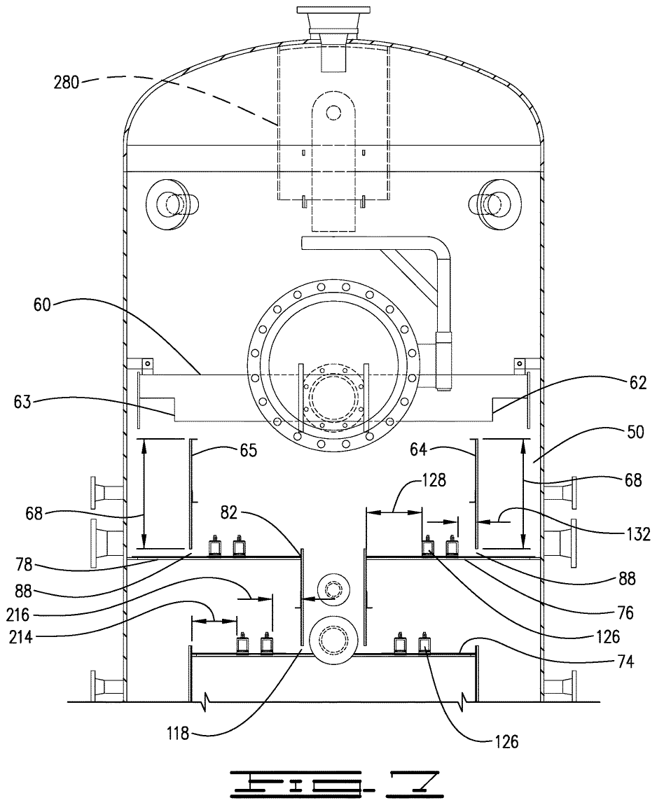

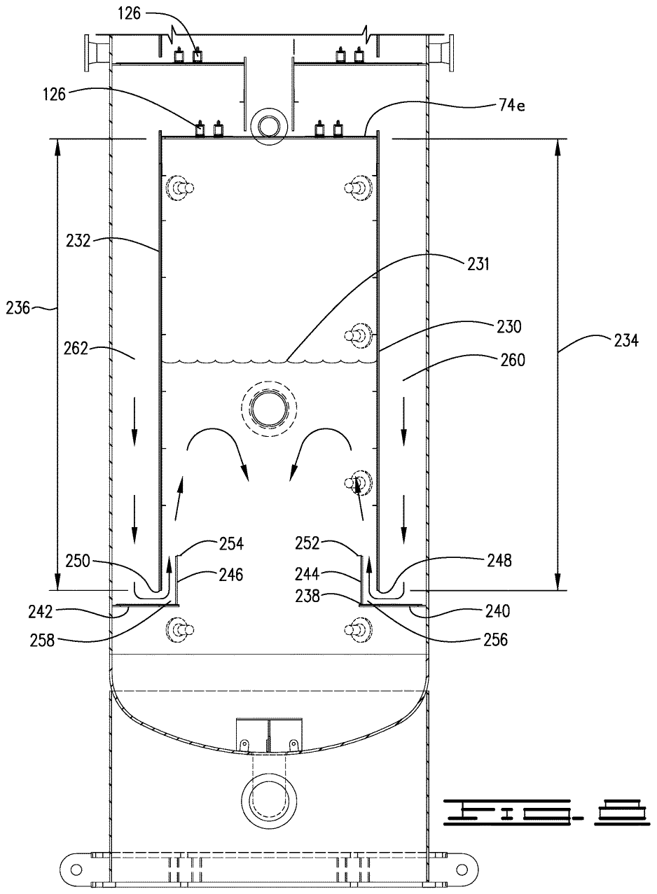

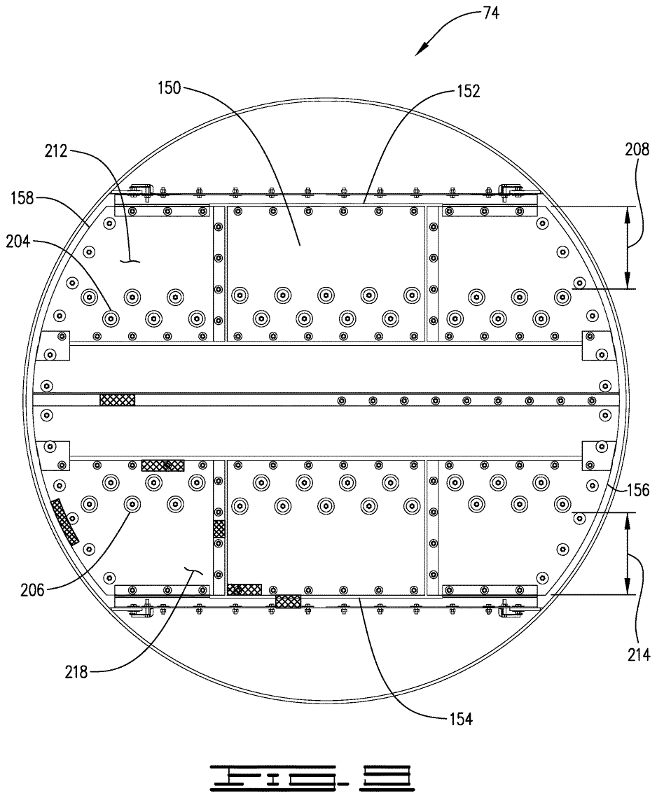

### DESCRIPTION OF AN EMBODIMENT

In the following descriptions and drawings, identical components are labeled with the same reference numerals throughout. Certain elements may be shown in schematic form for clarity, and variations in specific embodiments may be made without deviating from the scope of the invention.

Unless otherwise specified, terms such as “upstream,” “downstream,” “upper,” “lower,” “horizontal,” and “vertical” refer to relative positions within the tower and are not intended to impose strict geometric orientations.

Unless otherwise specified, use of the terms “connect,” “engage,” “couple,” “attach,” or any other like term describing an interaction between elements is not meant to limit the interaction to direct interaction between the elements and may also include indirect interaction between the elements described.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, use of the term “plurality” is meant to convey “more than one” unless expressly stated to the contrary. The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The system disclosed herein is a system for degassing liquids. In one embodiment the system is a system for removing H₂S from a liquid, which in one example is water. Although water is the disclosed liquid being treated by the system, it is understood that the system disclosed may be used to degas other liquids. Disclosed herein is a system for degassing comprising a multi-stage stripping tower 10 configured to remove H₂S from a liquid, and in the described system water. Stripping tower 10 incorporates optimized tray configurations, extended downcomers, a submerged seal pad, and a controlled sweet gas injection system to improve separation efficiency in aqueous service. Stripping tower 10 improves upon existing designs by providing enhanced residence time management and re-entrainment prevention, features that are not present in conventional water treatment towers. As further described herein, gas injection into the flowing liquid through bubble caps, or other gas-liquid contact devices, such as float valves and fixed valves, occurs close to the upstream downcomer where the liquid enters a particular tray. Each tray will have a surface in which no bubble cap or other contact device is located, to allow spreading of the liquid which encourages gas liquid separation. Stripping tower 10 may be skid-mounted to allow rapid installation and removal, and its modular design enables multiple towers to be arranged in parallel to accommodate larger volumes of water while maintaining low sweet gas injection rates per barrel.

Stripping tower 10 has a liquid inlet 15 for receiving liquid, for example water, with gas therein. For example, water with H₂S is delivered into stripping tower 10 through liquid inlet 15. The gas may be present in the water as bubbles or may be in solution when it enters stripping tower 10. Stripping tower 10 receives a sweet gas through a sweet gas inlet 20 positioned at or near a lower end of stripping tower 10. Sweet gas as used herein means a gas with little or no H₂S or other sulfur compounds. Typically “sweet gas”, and as used herein refers to natural gas with less than 4 ppm (parts per million) of H₂S. While chemicals may be used in the cleanout of the tower no chemicals are added to the water being treated. It is also not necessary to the operation of the stripping tower 10 to add pressure, or temperature. A compressor may be used if desired to move gas through the stripping tower 10, and temperature may be added if desired, but in many implementations neither is needed.

The primary component of sweet gas is methane, and may include smaller amounts of ethane, propane and butane. Stripping tower 10 has a sour gas outlet 25 at or near an upper end thereof and a sweet water outlet 30 at or near a lower end thereof. Water is delivered to liquid inlet 15 through a liquid inlet conduit 32 connected to a water source, for example a source of sour water such as produced water from oil and gas operations or wastewater from industrial processes. Sour water is water that has an unacceptable level of H₂S. A sweet gas inlet conduit 34 delivers sweet gas to sweet gas inlet 20. A sour gas outlet conduit 36 is connected to sour gas outlet 25. The exiting gas with H₂S therein may be routed to a vapor recovery unit, flare, or other gas treatment system. A sweet water outlet conduit 38 communicates the exiting sweet water to a desired location, for example a storage tank, separator or upstream processing unit. A plurality of service lines 40 are communicated with an interior of the stripping tower 10 through valves 44. For towers where high solids or a high chance of two liquid phases exists, cleanout ports where different stages can be accessed with tools and a vacuum truck hose to clean the stages out. As seen in the figures, some stages have a smaller port on top for easy access of an inspection camera or other cleaning tools. The ports also double as downcomer skim drains to skim out possible immiscible liquids from the tower downcomers. Light immiscible liquids can be a problem with water towers as the light immiscible liquid takes up downcomer volume and creates a liquid-liquid interface that makes it difficult for gasses to escape at ultra-low liquid rates. Service lines 40 may be used to inject chemicals or other materials into the tower for cleaning or other purposes and may also be used to allow fluid and/or debris to be pushed out of the interior of the tower. Valves 44 are normally closed so that there is no communication into service lines 40 during operation of the stripping tower 10.

Stripping tower 10 has a tower shell 48 and is a structured stripping system that consists of multiple functional sections, including an inlet distribution and initial degassing section 50, a staged tray section 52, and an extended downcomer and seal pad section 54. Each of sections 50, 52 and 54 contribute to degassing by providing residence time, controlled gas-liquid interaction, and re-entrainment prevention. The system includes a controlled sweet natural gas injection range of about 0.001-1.000 MCF/BBL to enhance stripping efficiency in aqueous solution. In other embodiments, narrower ranges such as 0.01-1.0 MCF/BBL or 0.1-1.0 MCF/BBL may be employed, as well as other intermediate ranges. Flow rates for gas can be calculated with models, for example HySys, using real gas analysis and liquid analysis data. Stripping tower 10, in one embodiment, is skid-mounted to enable rapid deployment and to allow multiple towers to be operated in parallel for higher water throughput while maintaining low gas injection rates per barrel. In one arrangement, sweet gas inlet 20 is positioned within the downcomer and seal pad section 54 as described in more detail herein. The exiting gas with entrained H₂S is routed to a vapor recovery unit, flare, or other gas treatment system.

First section 50, the inlet distribution and initial degassing section, of the stripping tower 10 comprises an inlet distribution assembly configured to stabilize incoming water and promote initial degassing. In one embodiment, the inlet distribution includes an inlet tee 60 with outlet ports 62 and 63 positioned above the trays at the top of the stripping tower 10 to evenly disperse water across the stripping tower 10 cross-section. Water is delivered through ports 62 and 63 into an area between a pair of opposed false downcomers 64 and 65 and an inner surface 66 of stripping tower 10. Inner surface 66 is defined on tower shell 48. False downcomers 64 and 65 are attached to the tower shell 48 with brackets or other known means. False downcomers 64 and 65 have depth 68 and a width 69. Width 69 in some implementations may be greater than the depth 68. The downcomer width is maximized to increase the gas-liquid interface area, enhancing separation efficiency, while maintaining sufficient hydrostatic head and gas seal integrity. In one implementation, the width 69 may be at least about 1.0-2.0 times the depth 68 and may be at least about 1.5 times the depth 68.

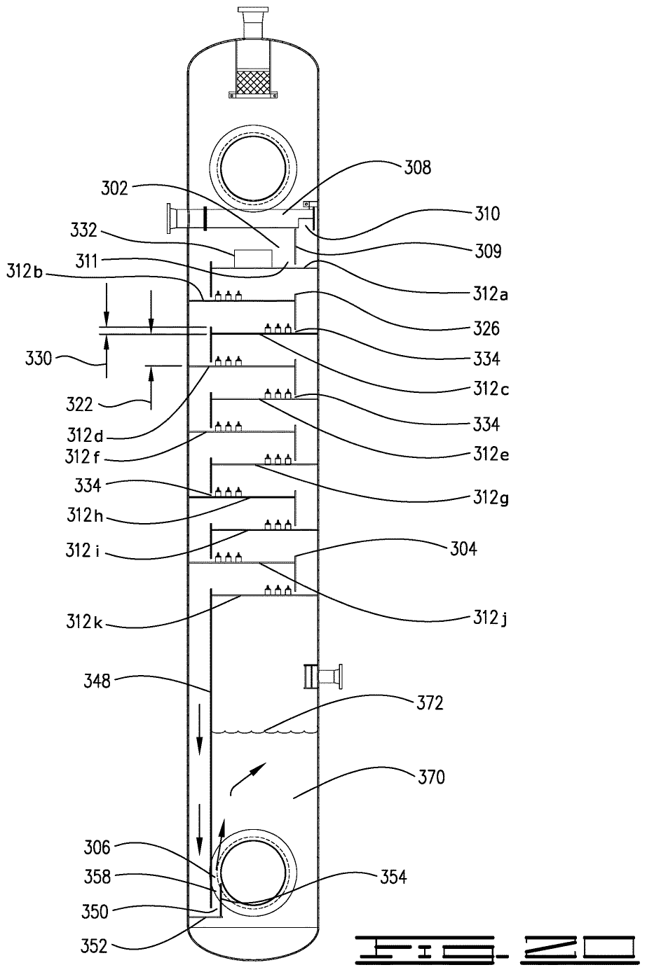

Stripping tower 10 comprises a plurality of staged trays 70. In the described embodiment, there are 10 staged trays 70. A tower with 10 staged trays will meet a desired efficiency for different flow rates, by simply increasing the volume of the tower, as opposed to adding/removing trays. First section 50 may further include calming zones, chimneys, or equivalent features to disengage free gas and prevent excessive foaming before the water progresses to the staged tray section 52. An example of a chimney 71 is shown in FIG. 19. Chimneys, when utilized, will be in first section 50.

Staged trays 70 include first and second tray configurations 72 and 74. The uppermost of the trays in the described implementation is of tray configuration 72. Tray configuration 72 comprises a split tray with tray decks 76 and 78. Tray decks 76 and 78 are generally identical and include opposed straight edges 80 and 82 respectively, and curved portions 84 and 86 respectively. Tray 72 is essentially a circle with a section cut from the middle thereof. Tray stages alternate between trays 72 and 74 in the stripping tower 10 and will be referred to with a letter subscript for ease of identification. False downcomers 64 and 65 are connected to tower shell 48 above the uppermost tray decks 76a and 78a of uppermost tray 72a. Gaps 88 are defined between false downcomers 64 and 65 and the tray decks 76a and 78a to allow water to flow thereunder.

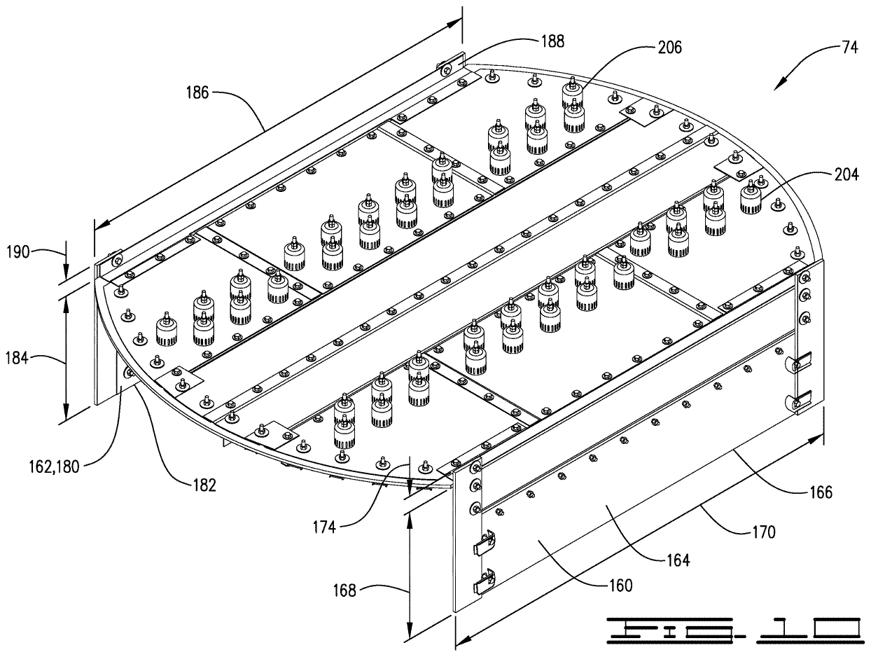

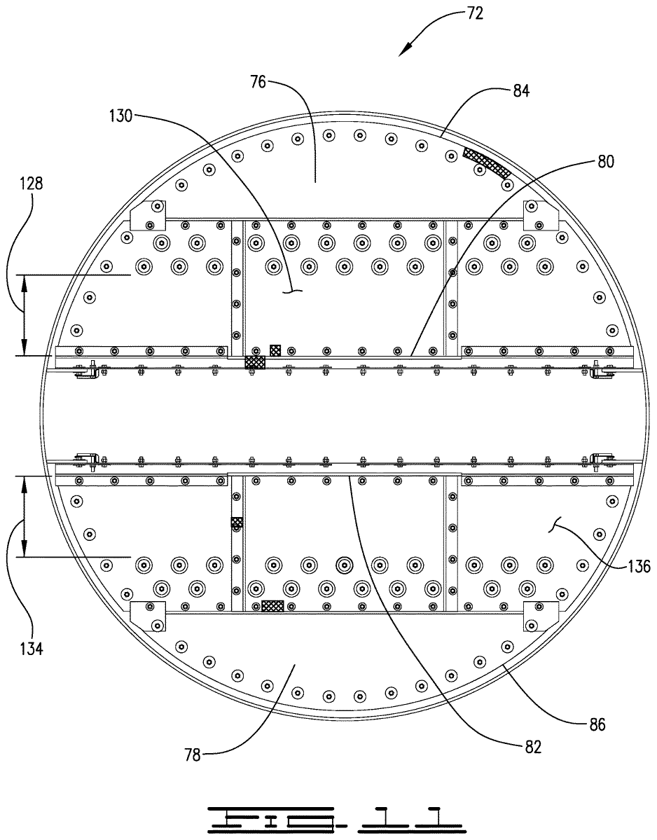

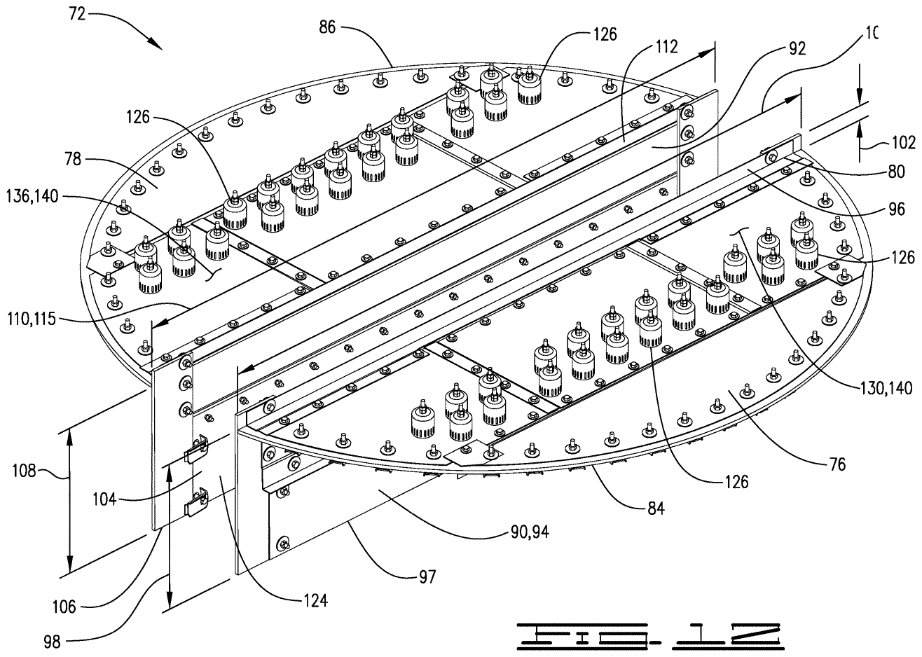

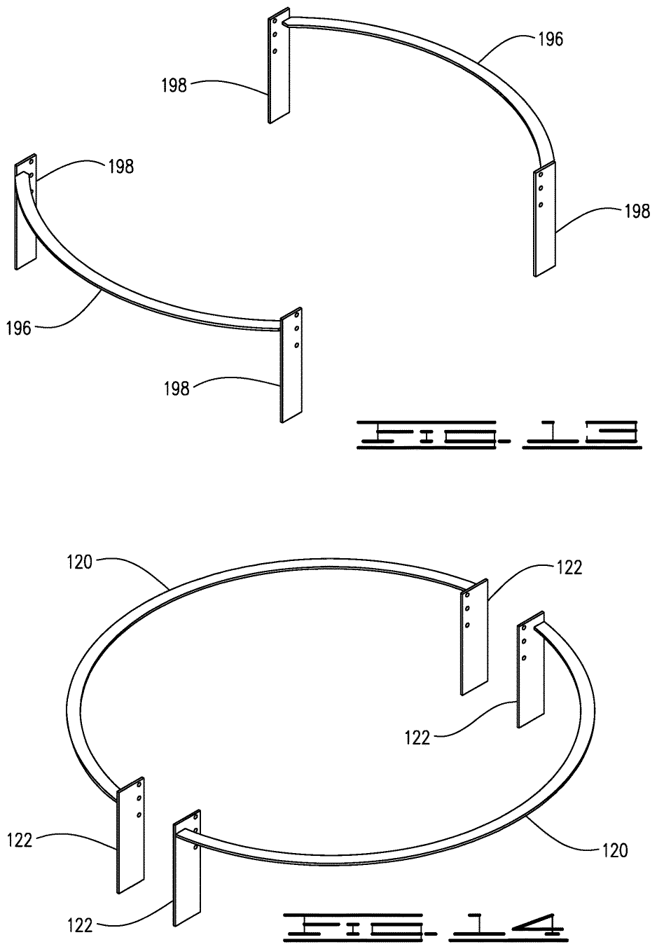

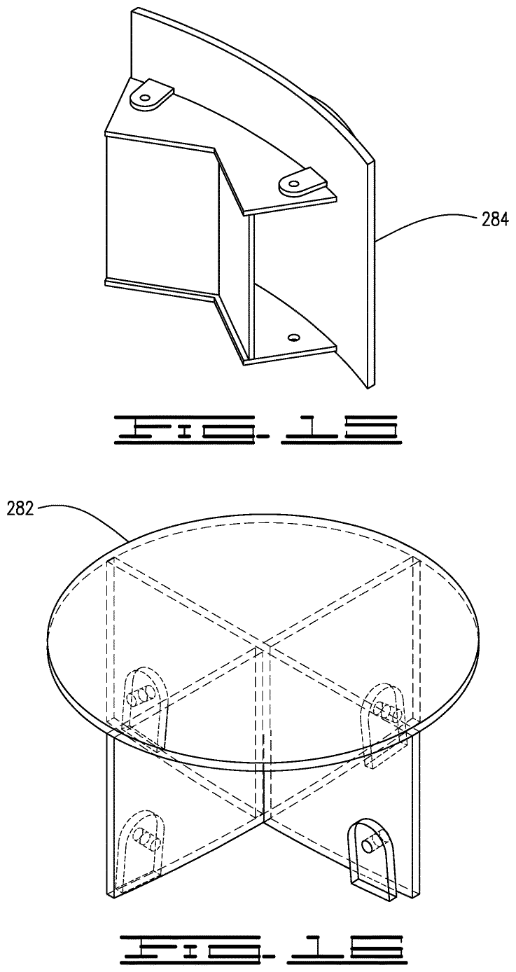

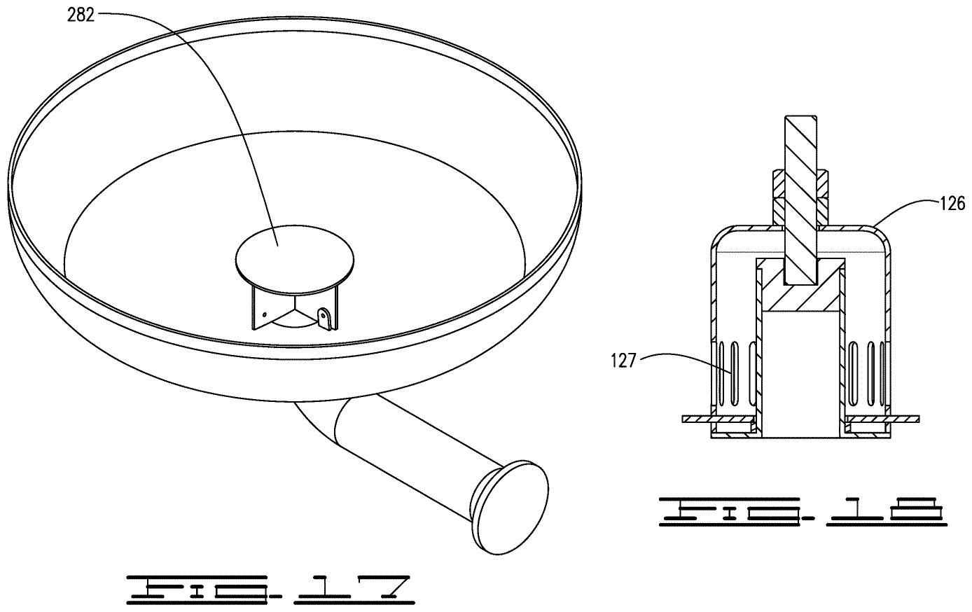

Tray 72 is seen better in FIGS. 11 and 12. Tray, or stage 72, has vertical plates 90 and 92 attached to the inner edges 80 and 82 of tray decks 76 and 78 respectively. Vertical plates 90 and 92 define opposed internal downcomers and opposed weirs. Vertical plate 90 defines a downcomer 94 extending downward from tray deck 76 and a weir 96 extending upwardly therefrom. Downcomer 94 has lower edge 97 and has depth 98 and width 100. Weir 96 has a height 102 that is greater than the height of bubble caps or valves attached to tray 72 as explained in more detail herein. Weir 96 has length 103 that is the same as width 100 of downcomer 94. Depth 98 is less than width 100. Vertical plate 92 defines a downcomer 104 extending downward from tray deck 78 with lower edge 106. Downcomer 104 has a depth 108 and a width 110. Vertical plate 92 defies a weir 112 with a height 114 and a length 115 extending upwardly from tray deck 78. Length 115 and width 110 are the same. Height 102 is generally identical to height 114. Depth 108, which is the same as depth 98, is less than width 110, which is the same as width 100. Downcomers 94 and 104 define gaps 116 and 118 with the tray 74 therebelow. A connecting ring 120 with bolting bars 122 may be used to attach vertical plates 90 and 92. Support rings may be welded or otherwise connected to tower shell 48 on the interior thereof to support trays 72. A space 124 is defined between downcomers 94 and 104. The width 100 and 110 of the downcomers 94 and 104 is as wide as will fit within the tower, and in some case may engage the inside 66 of the tower shell 48. Widths 100 and 110 may be larger than the depths 98 and 108 and in one implementation may be at least about 1.0 to 2.0 times as deep, and in one implementation may be about 1.5 times wider than deep. The width of the downcomers 94 and 104 determines the surface area of gas-liquid interface. The gas-liquid interface area is the surface where gas contacts liquid for mass transfer. A wider downcomer increases this area, improving the opportunity for H₂S to transfer from the liquid to the gas phase. By maximizing the gas liquid interface, the efficiency of the tower is increased. As explained above, the downcomer width is maximized to increase the gas-liquid interface area, enhancing separation efficiency, while maintaining sufficient hydrostatic head and gas seal integrity. Weirs 96 and 112 have a length sufficient to span the distance of the tower shell wall. In other words, the length of weirs 96 and 112 is such that the weirs 96 and 112 will touch, or be proximate the inner surface of the tower shell 48 at both ends thereof. The length of weirs 96 and 112 is generally identical to the widths 100 and 110 of downcomers 94 and 104.

Tray decks 76 and 78 have a plurality of bubble caps 126 thereon. Although bubble caps are disclosed, it is understood that other gas liquid contact devices, such as float valves or fixed valves may be used. On tray deck 76, bubble caps 126 are spaced from weir 96 a distance 128. As a result, a planar surface 130 is defined on tray deck 76 which has no bubble caps. The bubble caps 126 are positioned on tray deck 76 adjacent the downcomer from the tray 74 thereabove with no space, or only a small space 132 from the upstream downcomer thereabove to the bubble caps 126. The gas injection from the bubble caps is proximate the entry of the water to the tray 72.

On tray deck 78, bubble caps 126 are spaced from weir 112 a distance 134, which may be the same as distance 128. As a result, a planar surface 136 is defined on tray deck 78 which has no bubble caps. The bubble caps 126 are positioned on tray deck 78 adjacent the downcomer from the tray 74 thereabove with no space, or only a small space 138, which may be the same as distance 132, from the upstream downcomer thereabove to the bubble caps 126. The gas injection from bubble caps 126 into the water in the tower is thus proximate to the entry of the water to the tray 72 on both of tray decks 76 and 78. The planar surface areas 130 and 136 may be referred to as buoyancy release surfaces 140. Water in the tower will pool behind the weirs 96 and 112 prior to spilling over, which provides more residence time in the tower than other towers. As a result, gas bubbles can buoyantly rise to the gas-liquid interface and can be released upwardly in the tower. Thus, each tray, or stage has both a gas injection zone (the area in which the bubble caps 126 are located) and a gas release zone, the gas release zone comprised of the planar surfaces 130 and 136. The gas injection zone may be referred to as the active area on trays 72, and the gas release zones as the passive area.

Trays 74 may comprise a tray deck 150 with straight outer edges 152 and 154 and curved connecting portions 156 and 158. Vertical plates 160 and 162 are connected to outer edges 152 and 154 respectively. Vertical plate 160 defines external downcomer 164. Downcomer 164 has lower edge 166 and has a depth 168 and width 170. Width 170 in some implementations is greater than depth 168 which maximizes the gas-liquid interface as described above. Width 170 is such that it will extend to contact or almost contact the inner surface 66 of tower shell 48. Vertical plate 160 defines weir 172 with a height 174 from edge 152. Vertical plate 162 defines external downcomer 180 with lower edge 182. Downcomer 180 has lower edge 182 and a depth 184. Downcomer 180 has width 186. Width 186, which is the same as width 170 and may be greater than depth 184, which is the same as depth 170. The width 170 and 186 of the downcomers 164 and 180 may be at least about 1.0 to 2.0 times the depth, and in one implementation is at least about 1.5 times the depths 168 and 184 of the downcomers 164 and 188. Vertical plate 160 defines weir 188 with height 190. Gaps 192 and 194 are defined by lower edges 166 and 182 of downcomers 164 and 180 and the stage 72 therebelow. Weirs 172 and 188 have a length sufficient to span the distance of the tower shell wall. In other words, the length of weirs 172 and 188 is such that the weirs 172 and 188 will touch, or be proximate the inner surface of the tower shell 48 at both ends thereof. Connecting rings 196 with bolting bars 198 may be used in the assembly of trays 74. Support rings may be welded to the inner surface of the tower shell 48 to support trays 74. Spaces 200 and 202 are defined between external downcomers 164 and 188 and the inner surface 66 of tower shell 48.

On tray deck 150, bubble caps 126 are in spaced apart rows 204 and 206. Bubble caps in row 204 are spaced from weir 172 a distance 208, and are spaced from the downcomers on the tray 72 thereabove a distance smaller than distance 208. Bubble caps 126 in row 204 are thus proximate downcomer 94, so that they are positioned proximate the water entry for the tray 74. The gas injection from bubble caps 126 in row 204 into the water in the tower is thus proximate to the entry of the water to the tray 74. A planar surface 212 is defined on tray deck 150 between bubble caps 126 and row 204 in which no bubble caps exist. Bubble caps in row 206 are spaced from weir 188 a distance 214, and are spaced from the downcomers on the tray 72 thereabove a distance smaller than distance 214. Bubble caps 126 in row 206 are thus proximate downcomer 104, so that they are positioned proximate the water entry for the tray 74. The gas injection from bubble caps 126 in row 206 into the water in the tower is thus proximate to the entry of the water to the tray 74. A planar surface 218 is defined on tray deck The planar surface areas 212 and 218 may be referred to as buoyancy release surfaces 220. Water in the tower will pool behind the weirs 172 and 188 prior to spilling over, which provides more residence time in the tower than other towers. As a result gas bubbles can buoyantly rise to the gas-liquid interface and can be released upwardly in the tower. Thus, each tray, or stage 74 has both a gas injection zone (the area in which the bubble caps 126 are located) and a gas release zone, the gas release zone comprised of the planar surfaces 212 and 218.

The design of the trays 72 and 74 with straight edges 80 and 82 and curved portions 84 and 86 on tray 72, and straight edges 152 and 154 and curved connecting portions 156 and 158 on tray 74, promotes even liquid distribution and reduces turbulence that could otherwise hinder separation efficiency. The staged arrangement (i.e. the alternating arrangement of trays 72 and 74) ensures a controlled pressure drop across the stripping tower 10 while maintaining adequate gas residence time. The design and configuration of the downcomers 94, 104, 164 and 180 is such that the tower can have a greater density of trays per height measure. In embodiments in which the width of the downcomers is increased, and the depth decreased the downcomers can be spaced less than two feet apart, which is the common spacing. The downcomers may be spaced apart as little as one and one-half feet so that the density of trays in the tower is increased meaning that tower size can be decreased while achieving efficient removal of H₂S.

The lowermost of trays 74, tray 74e, has a pair of false downcomers 230 and 232 with identical lengths 234 and 236 respectively. The length of the false downcomers is greater than the length of the other downcomers in the tower. Positioned below downcomers 230 and 232 is a submerged seal pad 238. Seal pad 238 is comprised of first and second curved segments 240 and 242, with legs 244 and 246 extending upwardly from the straight edges of segments 240 and 242 respectively. False downcomers 230 and 232 have lower edges 248 and 250 and extend downwardly past the upper edges 252 and 254 of legs 244 and 246 into spaces 256 and 258 between legs 244 and 246 and the tower shell 148. Spaces 260 and 262 are defined between false downcomers 230 and 232 and the inner surface 66 of tower shell 48. The active area on the trays may be between about 30% and about 50% of the passive area, and in one embodiment may be about 40% of the passive area.

The water in the tower will pool at the bottom of the tower in what may be referred to as a water bath. In existing towers, liquid falls directly into the water bath which creates a froth and does not promote gas removal. Extended downcomers 230 and 232 extend below a water level 231 so that the water is discharged beneath the water level 231, which reduces surface agitation. Seal pad 238 functions to prevent, or at least minimize, re-entrainment of stripped gas into the exiting water. Seal pad 238 redirects liquid velocity upward toward the liquid surface and away from the liquid outlet as depicted by the arrows. By redirecting the liquid, the gas flow path to the exit is extended which provides increased opportunity for gas bubbles to combine. Because the water flows upwardly in the seal pad, the motion of escaped gas is directed upwardly toward the gas liquid interface and toward the gas outlet, and the redirection promotes disengagement of entrained gas and facilitates the release of remaining free H₂S (gas that exists in the water as bubbles). In addition, residence time of the liquid in the stripping tower 10 is increased. The additional residence time at the seal pad enables further disengagement of dissolved gas before the water leaves the stripping tower 10. In addition the gas inlet port 20 may be located within downcomer section 54, enabling fresh stripping gas to enter stripping tower 10 and enhance the degassing action at the final stage.

A plurality of sensors, including a high level sensor 270, an intermediate high level sensor 272, a low intermediate level sensor 274 and a low level sensor 276 will sense the water level in the stripping tower 10. Valve, or liquid level controller 278 will receive signals for the sensors and will open when to release liquid and close to prevent water flow when the water level reaches predetermined levels in the tower. Liquid level controller 278 regulates the release of fluid through liquid outlet 30 and is configured so that fluid is not discharged until the water level reaches the set point corresponding to the liquid level controller 278. When the level rises above the set point, which is at the intermediate high level sensor 272 the liquid level controller opens valve 278 to permit flow; when the level drops below the desired set point for the release of liquids, which is the intermediate low level sensor 274 the valve closes, ensuring a consistent seal and stable liquid retention time. The extended downcomers 230 and 232 and seal pad 238 create a holding chamber in which water is retained prior to exiting the tower, which increases residence time to allow the continued release of H₂S gas from the water.

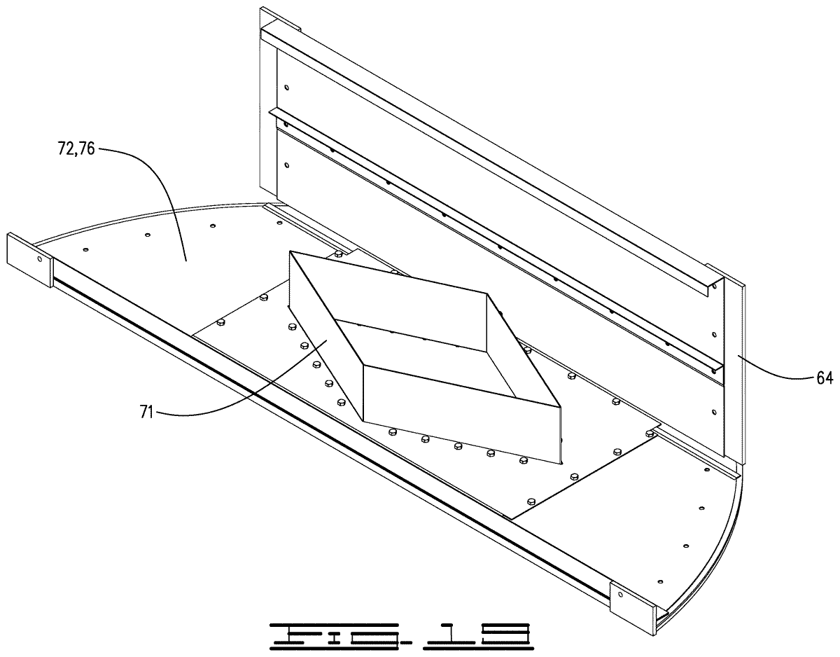

Each of the trays 72 and 74 is fitted with gas-liquid contact devices such as bubble caps, float valves, or fixed valves. In the described implementation, bubble caps 126 are disclosed. An example of a bubble cap is shown in FIG. 18. Gas passes into bubble caps 126 though openings in the bottom thereof and passes out through slots 127. Slots 127 have a height less than the height of weirs 96, 112, 172 and 188. Water entering first section 50 is distributed via tee 60 and partially degassed before flowing downward onto trays 72 and 74. Water flows across trays 72 and 74, while rising sweet gas passes upward through the contact devices, such as the bubble caps 126. Water flows into stripping tower 10 and onto tray 72a. Water will flow over the weirs 96 and 112 on tray 72a and will flow onto tray 74a therebelow. Water will flow through the gaps 116 and 118 between the downcomers 94 and 104 and the tray 74a therebelow and will flow outwardly on tray 74a over weirs 172 and 188. Water will flow onto tray 72b therebelow and will flow through gaps 190 and 192 between downcomers 164 and 180 and the tray decks 76 and 78 of tray 72b therebelow. Water will flow over weirs 96 and 112 and through space 124 between downcomers 94 and 104 onto the tray 74b therebelow. The flow continues down as described through all stages. The downcomers 94, 104, 164 and 180, along with weirs 96, 112, 172 and 188 provide controlled liquid transfer between trays while maintaining gas-liquid contact efficiency. First section 50 ensures stable distribution of produced water across the trays, while trays 72a-72e and 74a-74e continue staged stripping prior to entering section 54 which is the extended downcomer and seal pad 54 section.

Other features incus a mist eliminator 280 through which exiting gas passes prior to leaving sour gas outlet 25. Mist eliminators are known in the art. A vortex breaker 282 is positioned at the lower end of the stripping tower 10 to produce even flow out of outlet. The vortex breaker 282 prevents induced swirling flow (similar to a whirlpool) that can develop a gas column (vortex) from forming and enabling gas to exit out of the stripping tower 10 through the water outlet. A gas inlet baffle 284 is positioned at sweet gas inlet 20. The gas inlet baffle 284 spreads the gas evenly in the chamber and ensures that gas will not form a preferential flow path through the trays.

In operation, each tray stage 72a-e and 74a-e provides residence time and counter-current contact between rising sweet gas and descending water. The gas devices, bubble caps 126 in the described embodiment, but may be float valves, or fixed valve allow stripping gas to disperse into the water, removing H₂S progressively. Internal downcomers 94 and 104 and external downcomers 164 and 180, along with weirs 96, 112, 172 and 188, and gaps 106 and 108 and gaps 116, 118, 190 and 192 between stages regulate liquid transfer to prevent flooding or short-circuiting. The arrangement ensures efficient contaminant removal while maintaining hydraulic balance. By maintaining substantially uniform liquid depth and gas distribution across successive stages, the tray arrangement achieves efficient contaminant removal through repeated gas-liquid contact while preserving hydraulic balance throughout the tower. As used herein, hydraulic balance refers to the ability of the tower to sustain stable liquid and gas flow across multiple stages without localized overloading or flow starvation, enabling consistent stripping performance over a wide range of operating conditions.

The structured tray configuration promotes gas-liquid contact and controlled residence time. Each of the trays 72 and 74 is positioned to allow downward liquid flow while sweet gas rises counter-currently through perforations or openings in the tray decks. This arrangement ensures thorough contact between the injected sweet gas and the liquid phase, enhancing the stripping of H₂S while maintaining low gas usage. The trays may be equipped with bubble caps, or other gas liquid contact devices as previously explained configuration reducing mechanical complexity, lowering pressure drop, and improving fouling resistance compared to conventional bubble cap designs.

Gas introduced into the tower through sweet gas inlet 20 rises counter-currently through the sections, collecting entrained hydrogen sulfide and other contaminants from the water. The stripped gas exits through sour gas outlet 25 positioned at or near the top of the tower. The exiting gas stream can be directed to a vapor recovery unit, thermal oxidizer, or other emissions control equipment for treatment in compliance with environmental regulations. The modular construction of stripping tower 10 enables scalability of operation. Towers may be fabricated as skid-mounted units, allowing multiple towers to be deployed in parallel to accommodate higher flow rates. This arrangement maintains a minimum sweet gas injection rate per unit volume of fluid, improving operating efficiency and reducing operating costs. The tower design further permits substitution of alternative contact devices, variation in the number of stages, or adjustment between single and double-pass tray configurations.

In operation, water enters the stripping tower 10 through inlet distribution tee 60 and undergoes a staged degassing process. Sweet natural gas is injected at controlled rates through gas injection port to enhance stripping efficiency. Stripping tower 10 in the described implementation is a double-pass tower, and is designed to operate at varying flow rates. In one example a tower designed for a nominal sour-water throughput of approximately three thousand barrels per day may be configured to remove greater than approximately ninety percent of the free (molecular) H₂S present in the inlet water. In one representative operating condition, sour water containing approximately forty to fifty pounds per hour of total H₂S is introduced into the tower at a liquid flow rate of approximately three thousand barrels per day, while sweet natural gas is injected at a rate sufficient to provide a gas-to-liquid ratio that promotes effective mass transfer. As previously noted, flow rates for sweet gas introduced into the tower can be calculated with models, for example HySys, using real gas analysis and liquid analysis data. Under such conditions, more than ninety percent of the free H₂S is transferred from the liquid phase into the gas phase, with the stripped water exiting the tower containing only a small residual fraction of free H₂S. Owing to the staged contact geometry, distributed liquid introduction, and controlled gas injection, the stripping tower 10 may operate with a turndown of up to approximately forty percent while maintaining similar free-H₂S removal performance. Accordingly, a tower designed for a nominal liquid flow rate of approximately three thousand barrels per day may maintain greater than approximately ninety percent free-H₂S removal at water flow rates as low as approximately eighteen hundred barrels per day and as high as approximately thirty-six hundred barrels per day. The ability to maintain removal efficiency over this range is attributable to the multi-pass configuration, effective gas-liquid contact area, and residence time provided within the tower. It is further recognized that total H₂S removal is influenced by liquid-phase chemistry. As water pH increases, a greater portion of the total sulfide is retained in solution in a dissolved, ionized form that is not volatile and is therefore not removable by gas stripping. Under such conditions, the stripping tower continues to remove a high percentage of the free H₂S fraction, while the remaining dissolved sulfide remains in the water phase. The graph in FIG. 25 is based on a hypothetical model generated by utilizing HYSYS and shows the amount of free H₂S gas removal for various flow rates and water conditions.

The design and configuration of the stripping tower 10 provides a greater turndown than is achievable in current towers. “Turndown” as is known in the art, refers to the operating capacity at which the tower can function effectively while maintaining desired mass transfer and separation. Typically H₂S removal towers are used in the downstream oil and gas industry, where liquid and gas flow rates a relatively controlled. The towers in those cases are designed for a specific flow rate, and have a low turndown, and likewise have a low high-end capacity. In other words existing towers do not allow for much, if any flow higher than the designed flow rate before flooding out will occur. The features of the stripping tower 10 that contribute to a high turndown and increased high-end capacity include, but are not limited downcomers 94, 104, 164 and 180 with width than depth as described herein, extended final stage downcomers 230 and 232 with a greater depth than the depth of other downcomers 94, 104, 164 and 180 so that the extended downcomers extend into the water bath below water level 231, trays 72 and 74 with both a gas injection area and a gas release area, and a seal pad 238 that reverses the water flow prior to exit of the water to direct gas upwardly, and also creates a holding chamber in which water is retained prior to exit from the stripping tower 10. For example, a tower designed to achieve approximately 90% removal of free (molecular) H₂S at a nominal water flow rate of three thousand barrels per day using the features disclosed herein may operate with a turndown of up to 40% and a high-end capacity increase of up to 20% while maintaining approximately 90% removal of the free H₂S fraction. In other words, a tower designed for a three-thousand-barrel-per-day water flow rate may maintain approximately 90% free-H₂S removal efficiency at water flow rates as low as twelve hundred barrels per day and as high as approximately thirty-six hundred barrels per day. It is further recognized that liquid-phase pH influences H₂S speciation, such that at elevated pH a greater portion of total sulfide exists in a dissolved, ionized form that is retained in solution and is not removable by gas stripping, thereby limiting total H₂S removal even when free H₂S removal efficiency remains high. In addition to the features noted, the stripping tower 10 provides for an increased density of trays.

Mounting the stripping tower 10 on a skid enables rapid and straightforward placement while also allowing for modular expansion by adding multiple towers in parallel to maintain peak efficiency per stripping tower. Stripping tower 10 is designed to be adaptable to different process conditions utilizing pressure controls. By optimizing tray density, residence time, and gas interaction, the stripping tower 10 provides a superior solution for H₂S removal by controlling pressure for various situations. The tower operates efficiently without the use of any chemicals added to the liquid, and without the addition of heat or pressure. As a result the tower disclosed herein may be placed and used effectively in environments where such additions are not possible. Temperature can be added if desired, and a compressor may be used to push gas through the tower if desired.

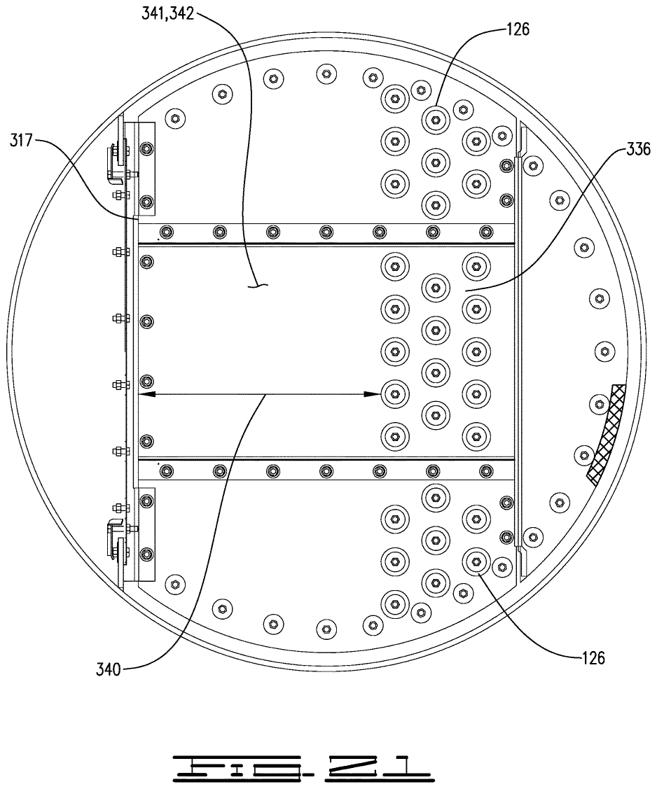

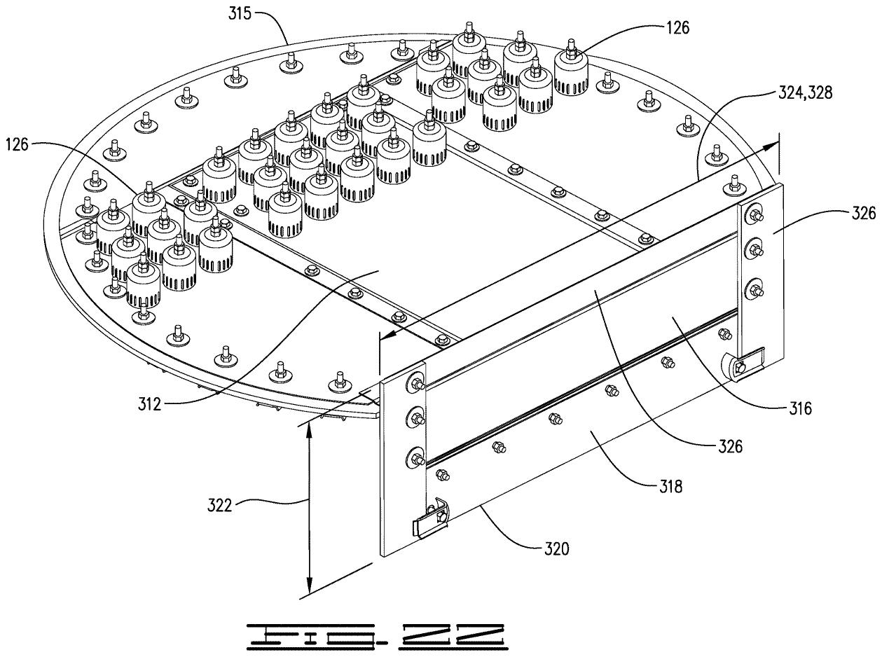

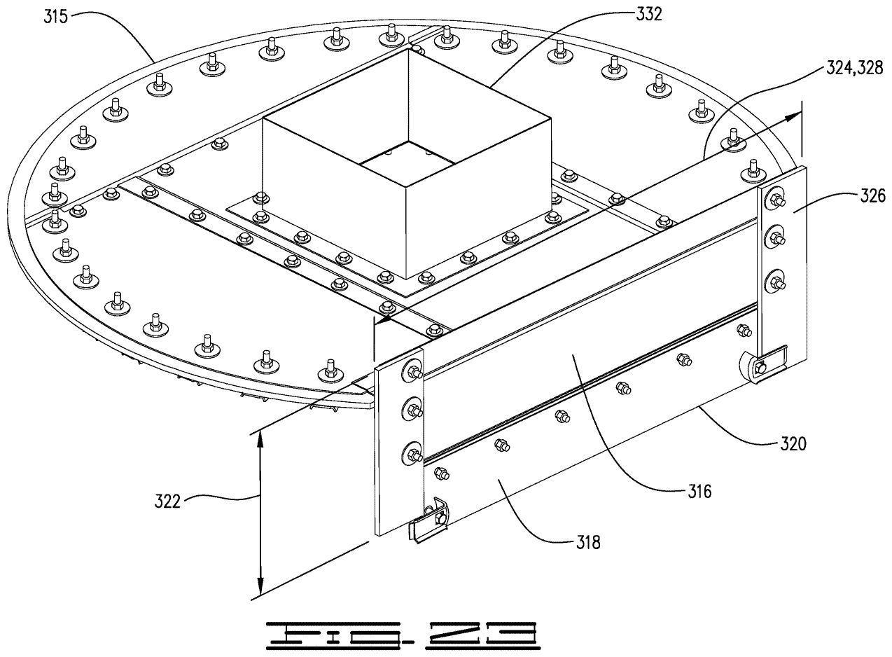

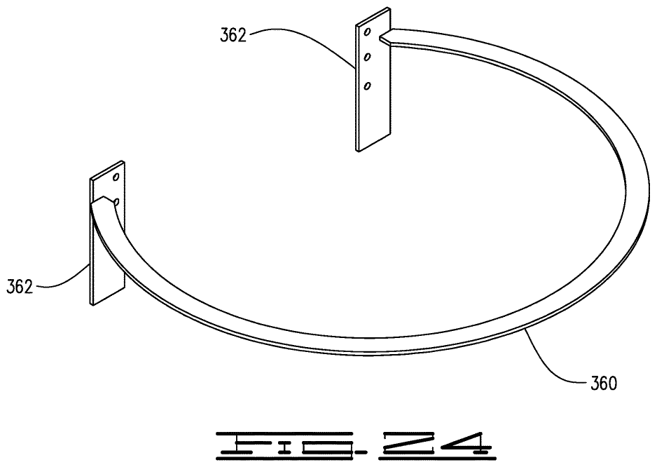

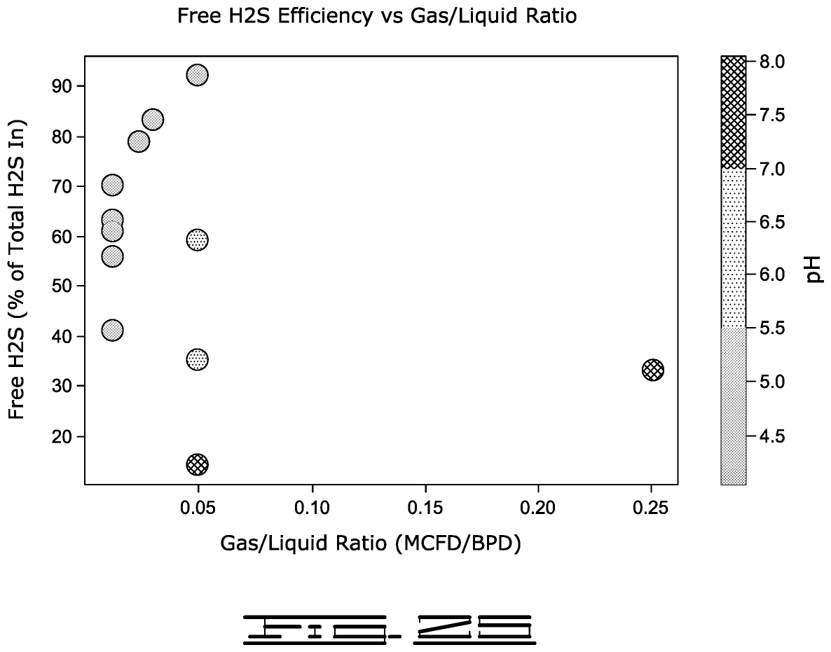

While the described embodiment is a double pass tower 10, an additional disclosed embodiment includes a single pass tower 300 operating on the same principles. FIG. 20 shows a single pass tower 300 with a first, or initial degassing zone 302, a second or staged tray section 304 and a third, or extended downcomer and seal pad section 306. Tower 300 has a plurality of trays 306, which in some cases may be referred to with a letter subscript for ease of identification. A feed pipe 308 with an opening 310 therein delivers water onto the uppermost tray 312a in the first, or initial degassing section 302 past a false downcomer 309. A gap 311 is defined between false downcomer 309 and tray 312a. Trays 312 comprise a tray deck 314 with a vertical plate 316 connected to a straight edge 317 thereof. Tray deck 314 has a curved edge 315. Vertical plate 316 defines a downcomer 318 with a lower edge 320 and a depth 322. Downcomer 318 has a width 324 that extends to the inner surface of the tower shell, and may be greater than the depth 322. For example, the width 324 of downcomer 318 may be at least about 1.0 to 2.0 times the depth 322 and in one embodiment at least about one and one-half times the depth.

Vertical plate 316 defines a weir 326 with a height 330 and with length 328 that extends sufficiently so that the ends of weir 326 are proximate to the inner surface of the tower shell. Length 328 is the same as width 324 of downcomer 318. Tray 312a may have a chimney 332. Chimney 332 is depicted as square, but may be other shapes. Chimney 332 operates the same as chimney 71. A gap 334 is defined between the downcomers 318 and the tray 312 therebelow. Trays 312b-312j have a plurality of bubble caps 126 positioned on the tray decks 314 thereof in a gas injection zone 336. Bubble caps 126 are spaced from weir 326 a distance 340 to define a planar surface 341 which has no bubble cap or other contact device. Planar surface 341 defines a buoyancy release zone 342 in which no bubble caps exist to allow the release of gas prior to the time water spills over weir 326. Thus trays 312(b)-312(j) have a gas injection zone 336 and a gas release zone 342. Bubble caps 126, and thus gas injection zones 336 have little, if any gap to the downcomer 318 extending from the tray thereabove, so that the gas injection zone is positioned proximate the water entry for each of the trays 312 that have bubble caps 326 thereon. Trays 312 are rotated 180 degrees from the adjacent tray 312 thereabove and therebelow.

Tower 300 has extended downcomer 348 and submerged seal pad 350. Submerged seal pad 350 comprises a curved segment 352 with a leg 354 extending upwardly from the straight edge of curved segment 356. Extended downcomer 348 extends into space 358 defined by leg 354 and the wall of the tower 300. Trays 312 may include a support ring 360 and bolting bars 362 and may be supported by mounting rings welded to the interior of the tower 300. Tower 300 has a sweet gas inlet 318, a sour gas outlet 320, a sour water inlet 322 and a sweet water outlet. A gap 324 is defined between downcomer 314 and the tray deck 310 therebelow.

The operation of tower 300 is like that described with respect to the double pass tower 10. Each tray 312 is rotated one-hundred eighty degree from the adjacent tray 312 thereabove and therebelow. Water flows into tower 300 over false downcomer 309 onto tray deck 314 of tray 312a, over weir 326 onto the tray deck 314 of tray 312b therebelow. Water flows through the gap 334 between the downcomer 318 of the tray 312a and the tray deck 314 of tray 312b therebelow. Gas is injected into the water through bubble caps 126, and gas is released from the water in the release zones on the trays 312, in addition to the release that occurs as the water flows, and as it reverses direction and is held in the seal pad section 308. The pattern repeats until water reaches seal pad section 308 which includes extended downcomer 348 and seal pad 350. Sensors will sense the level of water in seal pad section 308 and will allow water to flow out of the tower 300 when the water level is at the set point and will prevent flow when water reaches a low level. The water flow will reverse direction around the extended downcomer 348 and will be directed upward toward a water level 370 in a water bath 372 in the bottom of tower 300.

What is claimed is:

1. A stripping tower for removing hydrogen sulfide (H₂S) from water flowing downwardly therein, comprising:
an injection port for injecting sweet gas into the stripping tower;
a plurality of vertically spaced apart trays having gas-liquid contact devices thereon;
a downcomer extending downwardly a first depth from each tray, the downcomer and the tray immediately therebelow having a gap therebetween for the flow of water therethrough;
an extended downcomer positioned below a lowermost tray of the vertically spaced apart trays, the extended downcomer extending downward from the lowermost tray a second depth that is greater than the first depth; and
a seal pad positioned beneath the extended downcomer, wherein the seal pad reverses the direction of flow of the water from a downward direction to an upward direction toward a water level of a water bath in the stripping tower prior to the time the water exits the stripping tower.

2. The stripping tower of claim 1, wherein the gas-liquid contact devices are selected from the group consisting of bubble caps, float valves, and fixed valves.

3. The stripping tower of claim 1, wherein the extended downcomer extends downward below the water level of the water bath in the stripping tower.

4. The stripping tower of claim 1, wherein the seal pad increases residence time of the water in the stripping tower to improve gas separation efficiency.

5. The stripping tower of claim 1, wherein a width of the downcomers on the trays above the lowermost tray is greater than the first depth.

6. The stripping tower of claim 5, wherein the width of the downcomers on the trays above the lowermost tray is at least about one and one-half times the first depth.

7. The stripping tower of claim 1, wherein the trays are vertically spaced from one another a distance of about one and one-half feet.

8. The stripping tower of claim 1, wherein sweet gas is injected at a rate of about 0.001 to about 1.00 MCF/BW.

9. A method of stripping hydrogen sulfide (H₂S) from water, comprising:
introducing water with H₂S into a stripping tower having a plurality of vertically spaced trays with gas-liquid contact devices thereon;
flowing the water downwardly through the stripping tower to flow over a surface of the trays;
introducing sweet natural gas into the stripping tower so that it moves counter currently to the downward flow of the water in the tower;
injecting the sweet natural gas into the water with the gas/liquid contact devices as the water flows downward from tray to tray through the tower;
directing the water past an extended downcomer in the stripping tower; and
reversing the flow of the water in the tower below a lower edge of the extended downcomer prior to releasing the water through an exit.

10. The method claim 9, wherein sweet natural gas is introduced at a rate of about 0.0001 to about 1.00 MCF/BW.

11. The method of claim 10, wherein sweet natural gas is introduced at a rate of about 0.01 to about 1.00 MCF/BW.

12. The method of claim 9, wherein the gas-liquid contact devices comprise bubble caps.

13. The method of claim 9, wherein the vertically spaced trays comprise a plurality of trays with downcomers thereon, wherein the downcomers have a width that exceeds the depth of the downcomers.

14. The method of claim 9, further comprising creating a water bath in the bottom of the tower to increase the residence time of the water in the tower.

15. The method of claim 14, wherein the water bath has a water level, and wherein the extended downcomer extends below the water level.

16. A stripping tower for removing H₂S from water comprising:
a water inlet;
a sweet gas inlet;
a water outlet;
a plurality of vertically spaced trays with gas-liquid contact devices thereon over which the water flows, wherein sweet gas is injected into the water through the gas-liquid contact devices; and
a seal pad that reverses the direction of the flow of the water from a downward direction to an upward direction before the water passes out of the stripping tower through the water outlet.

17. The stripping tower of claim 16, wherein the trays have downcomers extending therefrom, and wherein the downcomers have a width greater than a depth of the downcomers.

18. The stripping tower of claim 16, further comprising an extended downcomer connected to and extending downward from a lowermost tray of the plurality of trays, wherein the extended downcomer extends into a water bath at the bottom of the stripping tower.

19. The stripping tower of claim 18, wherein the water flows downward past the extended downcomer and reverses direction around a bottom edge of the extended downcomer.

20. The stripping tower of claim 18, wherein the stripping tower has two extended downcomers.
